(19) United States
(12) Patent Application Publication
(10) Pub. No.: US 2023/0330800 A1
(43) Pub. Date: Oct. 19, 2023

(54) Production method of novel austenitic stainless steel kitchen knives and low-carbon high-chromium martensitic alloy powder

(71) Applicant: Haifa Zheng, Quanzhou (CN)

(72) Inventor: Haifa Zheng, Quanzhou (CN)

(21) Appl. No.: 18/340,883

(22) Filed: Jun. 25, 2023

(51) Int. Cl. B24B 3/54; B23P 15/28; C22C 38/50; C22C 38/48; C22C 38/46; C22C 38/44; C22C 38/04; C22C 38/02; C21D 9/18; C21D 10/00; B23K 10/02; C21D 8/00

(52) U.S. Cl. CPC B24B 3/54; B23P 15/28; C22C 38/50; C22C 38/48; C22C 38/46; C22C 38/44; C22C 38/04; C22C 38/02; C21D 9/18; C21D 10/005; B23K 10/027; C21D 8/005; B23K 2101/35

(57) ABSTRACT

The production method of the novel austenitic stainless steel kitchen knives and the low-carbon high-chromium martensitic alloy powder of the present invention include providing an austenitic stainless steel knife body. It cladding low-carbon high-chromium martensitic alloy powder on the austenitic stainless steel cutter body through high-frequency density laser pulse cladding process, tempering treatment, cutter face grinding, end face grinding, and edge processing; The invention adopts an austenitic stainless steel cutter body, and then adopts a high-frequency density laser pulsation cladding process to make a low-carbon high-chromium martensitic stainless steel at the cutting edge by plasma electrofusion.

### TECHNICAL FIELD

The invention relates to the technical field of cutting tools, in particular to a production method of novel austenitic stainless steel kitchen cutting tools and low-carbon high-chromium martensitic alloy powder.

### BACKGROUND

As a cutting tool, the hardness of the cutting edge is an important performance index. Martensitic stainless steel can be hardened by quenching to make its surface hardness above HRC50. Therefore, in order to obtain hardening of the cutting edge, all stainless steel knives on the market are made of martensitic stainless steel; But similarly, knives made of martensitic stainless steel have problems such as poor anti-corrosion and anti-rust performance, excessive precipitation of heavy metals, and unsafe food contact.

As the saying goes, “good steel is used on the blade”. In the prior art, the above problems are generally solved by the following three methods;

The first method is to plasma fused a layer of high-hardness martensitic alloy powder on the traditional martensitic stainless steel cutter body, so that the sharpness and durability of the blade can be significantly improved. However, the martensitic stainless steel cutter body still has problems such as poor anti-corrosion and anti-rust performance, excessive heavy metal precipitation, and unsafe food contact. At the same time, it also increases the manufacturing cost caused by the plasma melting process.

The second method is to use a bimetallic welding process to weld the knife body of austenitic stainless steel and the blade of high carbon martensitic stainless steel, and then perform heat treatment hardening and orthopedics after welding. But the cutting tool processed by this bimetallic welding process is extremely prone to deformation, air holes and welding cracks and other defective products. It leads to disadvantages such as low leveling rate and high process cost.

The third method is to plasma fused a layer of high hardness martensite powder on the austenitic stainless steel cutter body. However, since the melting point of austenitic stainless steel is much lower than that of martensitic stainless steel powder, and the thickness of conventional plasma electrofusion single-pass forming cannot exceed 2 mm. Therefore, it requires multiple cladding or low-speed cladding of 2-4 mm/s. However, low-speed cladding or multi-pass cladding has processing problems such as low cladding efficiency, low utilization rate of alloy powder, many defects (such as pores), and unilateral tilting of the cladding layer. This in turn leads to the problem that the final cladding cost is high and cannot be promoted in an industrialized manner.

In addition, when using the above-mentioned second and third metals involving martensite and austenite to process cutting tools, the strength of the two metals differs greatly. Therefore, in the traditional grinding process of the knife surface, we generally grind from the back of the knife surface to the middle of the knife surface, then grind from the middle of the knife surface to the edge of the knife surface, and finally polish the center of the knife surface; However, this kind of traditional knife surface grinding process easily leads to the formation of uneven ridge-shaped protrusions at the joint position between the cutting edge and the middle of the knife surface. Since the tool generates greater resistance during the cutting process, it causes the tool to push the cutting object outward during the cutting process without cutting smoothly, which in turn leads to adverse effects on the cutting performance and experience of the tool.

### SUMMARY

The base material of the knife surface of this plan is 300 series austenitic stainless steel. It can effectively solve the problems of low anti-corrosion and anti-rust performance, high hazard of heavy metal precipitation, and poor food-grade contact safety existing in traditional martensitic cutting tools;

On the basis of obtaining the austenitic stainless steel cutter with good cutter performance through plasma electrofusion, the cutter face of the austenitic stainless steel cutter body is reasonably divided. This makes the final new austenitic stainless steel kitchen knives have good anti-corrosion and anti-rust performance, good hardness, good cutting sharpness, and good sharpness and durability; The grinding sequence of the knife face of the present invention is sequentially processed in a coherent manner. It maximizes a reasonably smooth plane between the cutting edge area and the transition area to promote a clam edge angle on the cutting edge of the austenitic stainless steel body. Secondly, the HRC hardness of alloy powder with special formula is as high as 60-63 degrees due to the use of plasma electrofusion on the cutting edge. Therefore, it can greatly improve the hardness of the cutting edge, and has superior toughness and improved long-lasting sharpness of the blade.

Above-mentioned technical purpose of the present invention is achieved through the following technical solutions:

The production method of novel austenitic stainless steel kitchen knife comprises the following steps:

Knife body forming: provide austenitic stainless steel knife body;

Plasma electrofusion: cladding low-carbon high-chromium martensitic alloy powder onto the austenitic stainless steel cutter body through a high-frequency density laser pulse cladding process; Tempering treatment: tempering the austenitic stainless steel cutter body;

Grinding the knife surface: dividing the knife surface of the austenitic stainless steel cutter body into a cutting edge area, a transition area, and a knife back area;

End face grinding: along the extension direction of the cutting edge contour line of the austenitic stainless steel cutter body, carry out regional end face grinding on the cutting edge area, the transition area, and the knife back area one by one;

Carrying out integral end face grinding to the cutter face of described austenitic stainless steel cutter body;

Sharpening treatment: performing sharpening treatment on the austenitic stainless steel cutter body.

Therefore, this solution adopts austenitic stainless steel cutter body, which can effectively solve the problems of low anti-corrosion and anti-rust performance, high hazard of heavy metal precipitation, and poor food-grade contact safety existing in traditional martensitic stainless steel cutters; Secondly, in this scheme, a layer of low-carbon high-chromium martensitic alloy powder is plasma-fused on the surface of the austenitic stainless steel cutter body, so as to greatly improve the corrosion resistance and toughness of the cutting edge, and make its hardness reach HRC60-HRC63, which solves the problems of insufficient corrosion resistance and insufficient durability of good sharpness of traditional martensitic stainless steel knives. Secondly, on the combination of austenitic stainless steel cutter body and low-carbon high-chromium martensitic alloy powder, this program adopts high-power-density laser pulsation cladding process for plasma electrofusion step, thus solving the problem of traditional two-metal welding. The problems of welding deformation and welding cracks, as well as the problems of cladding layer collapse and porosity in the traditional plasma electrofusion process. It further improves the leveling rate of the tool and reduces the process cost of plasma electrofusion, so that this tool processing method can be better promoted.

The present invention reasonably divides the cutter face of the austenitic stainless steel cutter body, so as to plan the processing path of cutter face grinding; Secondly, we arrange the grinding sequence of the knife face of the austenitic stainless steel cutter body reasonably, and firstly carry out the first step of knife face grinding from the cutting edge area. Therefore, the first step of grinding the knife face is the cutting edge area reflected by the cutting performance of the austenitic stainless steel cutter body, and then the transition area is subjected to the second step of knife face grinding, followed by the third step of the knife back area grinding. Finally, we grind the entire knife face of the austenitic stainless steel knife body as a whole; It can be seen that the grinding sequence of the knife face of this scheme is sequentially processed in a coherent manner, so a reasonable smooth plane between the cutting edge area and the transition area can be made to the maximum extent. Compared with the traditional knife surface grinding process, the uneven ridge-shaped protrusions can be avoided between the cutting edge area and the transition area of this scheme, so as to promote the formation of a clam edge angle on the cutting edge of the austenitic stainless steel knife body, thereby improving user user experience.

To sum up, on the basis of obtaining an austenitic stainless steel tool with good tool performance through plasma electrofusion, this scheme divides the knife face of the austenitic stainless steel tool body reasonably. It makes the final new austenitic stainless steel kitchen knives have good anti-corrosion and anti-rust properties, good hardness, good cutting sharpness, and good sharpness and durability.

In some embodiments, before the plasma electrofusion step, the austenitic stainless steel cutter body is provided with a cutting edge extension area, which can avoid the impact on the austenitic stainless steel cutter during the initial and final processing of plasma electrofusion. The cutting edge of the body causes damage. Thus, the cutting edge extension zone extends along the cutting edge contour line direction of the austenitic stainless steel cutter body and protrudes from the austenitic stainless steel cutter body. We consider that the plasma electrofusion step will have a fire process at the beginning and a fire process at the end, which may cause unnecessary damage to the cutting edge of the austenitic stainless steel body. In some embodiments, before the step of forming the cutter body, it also includes a step of cold-rolling and hardening the raw material, that is, the soft-state raw material austenitic stainless steel is selected as the raw material for cold-rolling and hardening.

Therefore, for the raw material cold rolling and hardening step, we choose the soft raw material austenitic stainless steel with a thickness of about 3.5 mm as the raw material of the austenitic stainless steel cutter body for cold rolling and hardening processing, and the processing reduction rate is 28-30%; After cold rolling and hardening, the tensile strength of the hard raw material is T.S (N/mm2) 850-950, the yield strength is Y.S (N/mm2) 800-900, and the hardness is HV280-310. It completes the acquisition of the hardness of the knife face, and then meets the hardness requirement that the austenitic stainless steel knife body does not deform during use.

In some embodiments, in the high frequency density laser pulsating cladding process in the plasma electrofusion step, the plasma electrofusion speed is 10-15 mm/s, the pulsation frequency is 3-5 kHz, and the duty cycle is The ratio is 75-95%, and the laser power density is 250-350 W/mm2.

Therefore, this scheme provides the specific implementation parameters of the high power density laser pulsation cladding process, and adopts the high power density laser pulsation cladding process. Its laser power density of 250-350 W/mm2 is twice as high as that of traditional plasma electrofusion. It can fully melt two materials with different melting points to form a good metallurgical bond, and solves a series of problems derived from the large difference between the melting points of traditional austenitic stainless steel and martensitic alloy powder; Secondly, the cladding speed is increased to 10-15 mm/s, so that the plasma electrofusion has good processing efficiency; finally, the pulsating laser control process is adopted in the plasma electrofusion process. Modulation of void ratio to control the surface tension of the molten pool in plasma electrofusion to prevent the collapse of the molten pool. It thus makes the thickness of single-pass cladding reach 2.5-3 mm, thereby reducing the number of times of single-pass cladding, so as to effectively improve the processing efficiency.

In some embodiments, in the tempering treatment step, the tempering temperature is 160-200° C., and the tempering time is 4-6 hours.

Therefore, the tempering process carried out at this temperature can further improve the toughness of the austenitic stainless steel cutter body and the durability of sharpness through repeated tests. In some embodiments, the plasma electrofusion step includes: a plasma electrofusion mechanism and an orbital working platform capable of multi-axis linkage. The plasma electrofusion mechanism performs a high frequency density laser pulse cladding process through an orbital working platform.

Therefore, the track-type working platform of this solution adopts a multi-axis linkage structure to accurately control the position of the output end of the plasma electrofusion device, and it is driven by the motion of the linear module. It has the advantages of high precision, good stability, and high process controllability. It can accurately and accurately perform plasma electrofusion on the blade of the austenitic stainless steel cutter body, thereby greatly improving the qualified rate of blade cladding.

In some embodiments, a low-carbon high-chromium martensitic alloy powder, which can be applied to the production method of the novel austenitic stainless steel kitchen knives, is a mixture of iron-based alloy powder and titanium carbide alloy powder, wherein the mass proportion of iron-based alloy powder is 50-80%, and the mass proportion of titanium carbide alloy powder is 20-50%; In terms of mass percentage, the iron-based alloy powder includes 0.2-0.5% Mn, 0.6-0.9% Si, 0.55-0.75% Ni, 15-18% Cr, 0.05-0.09% P, 0.05-0.15% N, 0.2-0.3% C, 0.005-0.016% S, 0.16-0.35% Mo, 0.15-0.2% Nb, 8-12% Ti, 1-2.5% V, and the rest is Fe.

Therefore, we clad the alloy powder additive layer on the cutting edge of the knife body to obtain a high-hardness and high-toughness cutting edge layer with an HRC of 60-63 degrees to achieve excellent cutting ability.

In some embodiments, the orbital working platform includes an X-axis linear movement mechanism, a Y-axis linear movement mechanism, and a Z-axis linear movement mechanism; the X-axis linear movement mechanism is movably disposed on the movable end of the Y-axis linear movement mechanism. The Z-axis linear movement mechanism is movably arranged on the movable end of the X-axis linear movement mechanism. The plasma electrofusion mechanism is arranged on the movable end of the Z-axis linear movement mechanism.

Therefore, this solution adopts a multi-axis linkage structure through the track-type working platform of the three-axis linkage of the X, Y, and Z axes. It can accurately control the position of the output end of the plasma electrofusion mechanism, and it is driven by the movement of the linear module. It has the advantages of high precision, good stability and high process controllability. It can accurately and accurately perform plasma electrofusion on the cutting edge of the austenitic stainless steel cutter body, so as to greatly improve the qualification rate of the cutting edge cladding.

In some embodiments, in the face grinding step,

We use the first grinding wheel to roughly grind the end face of the austenitic stainless steel cutter body, and the first grinding wheel is a resin grinding wheel. Which is added with 25-35% white corundum material added in mass percentage;

We use the second sharpening wheel to grind the end face of the austenitic stainless steel cutter body, and the second sharpening wheel is a synthetic rubber grinding wheel. Among them, 10-15% black corundum and 15%-20% ceramic alumina are added in mass percentage.

Therefore, compared with the brown corundum material grinding wheel used in the first grinding wheel used for rough grinding of the end face, the rubber grinding wheel used in the second grinding wheel of overfine grinding. The invention changes the material of the grinding wheel, which is beneficial to improve the production efficiency, improve the flatness of the tool surface, improve the smoothness of the user in the cutting process, and improve the experience.

In some embodiments, sharpening includes:

Multi-stage sharpening:

The first level of sharpening is to roughly cut the edge of the austenitic stainless steel body to form a cutting edge angle;

The second level of sharpening, the austenitic stainless steel body is re-sharpened to reduce cutting resistance;

The third level of cutting edge is to repair the cutting edge of the austenitic stainless steel cutter body to repair the cutting edge angle left by the rough cutting edge and the too young double cutting edge.

Therefore, the traditional sharpening method is to use a dry or wet disc sharpening machine for one sharpening. In this plan, the austenitic stainless steel cutter body is sharpened in multiple stages, and the characteristics and functions of each stage are reasonably arranged to ensure the sharpness and durability of the cutting edge of the austenitic stainless steel cutter body to the greatest extent. This reduces the number of times the user will repeatedly sharpen the blade in the future, thereby facilitating the improvement of user experience.

In some embodiments, the multi-stage sharpening further includes: fourth-stage sharpening, grinding the cutting edge of the austenitic stainless steel cutter body to remove burrs on the surface.

Therefore, this solution specifically adopts four-stage sharpening, which can effectively remove surface burrs (such as batch edges) through the fourth-stage sharpening, so as to improve the smoothness of the knife surface of the finished tool.

In some embodiments, in the first stage of sharpening, the austenitic stainless steel cutter body is rough cut with an angle fixer to form a cutting edge angle;

In the second stage of sharpening, a sharpening machine is used to sharpen the cutting edge of the austenitic stainless steel cutter body;

In the third stage of sharpening, use a sharpening machine to repair the cutting edge of the austenitic stainless steel cutter body;

In the fourth stage of sharpening, the cutting edge is ground with a thousand impellers.

Among them, the angle fixer can make the edge inclination of one side of the austenitic stainless steel cutter body reach 12-13 degrees, so as to ensure the sharpness and durability of the edge of the austenitic stainless steel cutter body to the greatest extent, thereby reducing In the future, the number of times the user will repeatedly sharpen the blade, which is convenient for improving the user experience.

In summary, the present invention has the following beneficial effects:
1. The grinding sequence of the knife face of this scheme is sequentially processed in a coherent manner, which can make a reasonable smooth plane between the cutting edge area and the transition area to the greatest extent;
2. No uneven ridge-shaped protrusions can be formed between the cutting edge area and the transition area of this solution, so as to promote the cutting edge of the austenitic stainless steel cutter body to form a clam-edge angle, thereby improving the user's experience in use;
3. We use high-frequency density laser pulsation cladding process to clad low-carbon high-chromium martensitic alloy powder to austenitic stainless steel cutter body to solve the processing problems existing in the traditional fusion of two metals;
3. We have a multi-axis linkage plasma electrofusion output terminal, which can accurately plasma electromelt the blade;
4. Austenitic stainless steel cutter body has good toughness and durability of sharpness;
5. The super-hard and wear-resistant alloy powder material can give the blade good cutting performance, and can guarantee the sharpness and durability of the edge of the austenitic stainless steel cutter body to the greatest extent, thereby reducing the number of repeated grinding of the blade by the user in the future;
6. Austenitic stainless steel is used as the knife body, which has good anti-corrosion and anti-rust performance, no heavy metal precipitation hazard, and food-grade contact safety.

In general, the knife face grinding sequence of the present invention is sequentially processed in a coherent manner. It can make a reasonable and smooth plane between the cutting edge area and the transition area to the greatest extent, so as to promote the cutting edge of the austenitic stainless steel cutter body to form a clam edge angle; Secondly, due to the use of plasma electrofusion technology to clad a layer of specially formulated alloy powder on the cutting edge, the hardness HRC is as high as 60-63 degrees. Therefore, it can greatly improve the hardness of the cutting edge, and has superior toughness and long-lasting sharpness of the blade; the base material of the knife is made of austenitic stainless steel, which has good anti-corrosion and anti-rust performance, no heavy metal precipitation hazard, food grade The advantages of contact safety.

### BRIEF DESCRIPTION OF THE DRAWINGS

FIG. 1 is a work flow chart of the present invention;

FIG. 2 is a schematic diagram of the position relationship of the cutting edge extension zone of the present invention on the austenitic stainless steel cutter body;

FIG. 3 is the enlarged view of place A in FIG. 2;

FIG. 4 is the enlarged view of place B in FIG. 2;

FIG. 5 is a schematic diagram of the machining of the cutting edge area in the sharpening process of the present invention;

FIG. 6 is a processing schematic diagram of the transition region in the sharpening process of the present invention;

FIG. 7 is a processing schematic diagram of the blade back area in the sharpening process of the present invention;

FIG. 8 is a schematic diagram of the overall processing of the knife face in the sharpening process of the present invention;

FIG. 9 is a schematic diagram of the connection relationship between the track-type working platform, the plasma electrofusion mechanism, the fourth-axis linear movement mechanism and the fixing fixture according to the present invention.

Reference signs: 3, austenitic stainless steel cutter body; 31, edge area; 32, transition area; 33, blade back area; 35, edge extension area; 351, initial extension area; 352, end extension area; 41. Track type working platform; 41. X-axis linear moving mechanism; 42. Y-axis linear moving mechanism; 43. Z-axis linear moving mechanism; 5. Plasma electrofusion mechanism; 6. Fourth axis linear moving mechanism; 7. Fixed fixture.

### MODE OF CARRYING OUT THE INVENTION

The present invention will be described in further detail below in conjunction with the accompanying drawings.

### Embodiment One

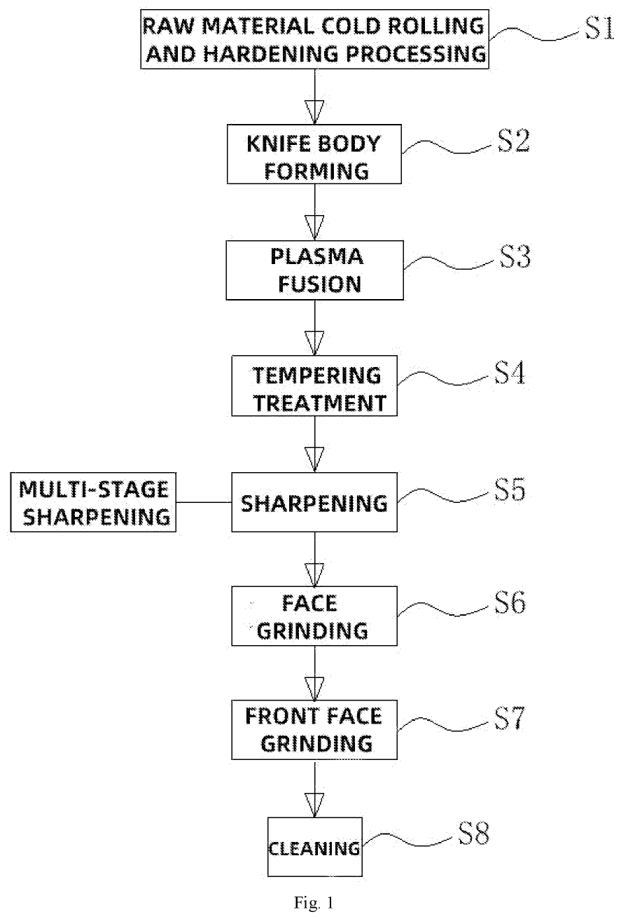

The production method of novel austenitic stainless steel kitchen knife, as shown in FIG. 1, comprises the following steps:

S1. Processing steps for cold rolling and hardening of raw materials:

We choose the soft raw material austenitic stainless steel with a thickness of 3.5 mm as the raw material of the austenitic stainless steel cutter body 3 for cold rolling and hardening processing, and the processing reduction rate is 28%; After cold rolling and hardening processing, the tensile strength of the hard raw material is T. S (N/mm2) 850, the yield strength is Y.S (N/mm2) 800, and the hardness is HV280. In this way, the acquisition of the hardness of the knife surface is completed, and then the austenitic stainless steel knife body 3 has the strength to resist yielding during use, and the hardness requirement of no deformation is achieved;

This solution uses 300 series austenitic stainless steel as the material of the tool, so it can effectively solve the following problems of the traditional martensitic tool. The details are as follows: 1. Guarantee of anti-corrosion and anti-rust performance; 2. The problem of heavy metal precipitation hazards caused by traditional ordinary stainless steel materials; 3. Food-grade contact safety issues. Correspondingly, the austenitic stainless steel cutter body 3 of this solution can have the advantages of good anti-corrosion and anti-rust performance, good hardness, good cutting sharpness, and good sharpness and durability.

S2. Knife body forming steps:

We provide austenitic stainless steel cutter body 3, that is, the processed austenitic stainless steel raw material in Si is made into austenitic stainless steel cutter body 3.

S3, plasma electrofusion step:

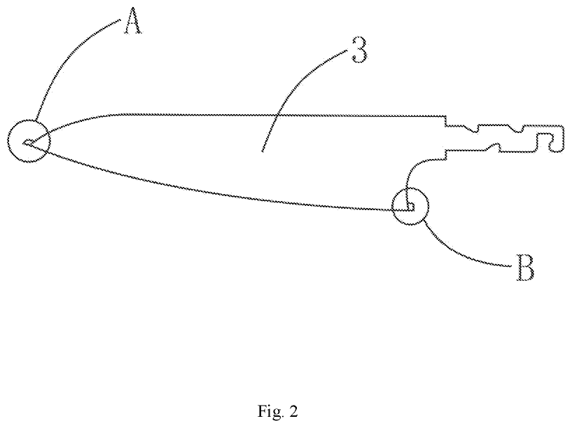

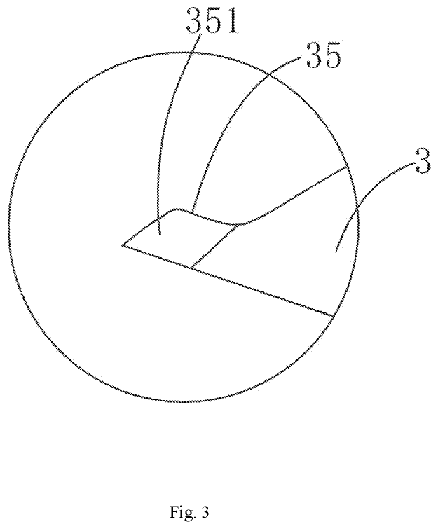

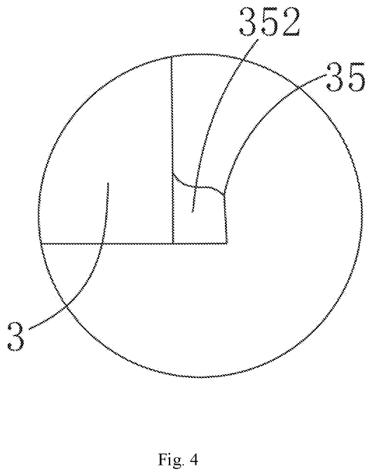

We clad the low-carbon high-chromium martensitic alloy powder onto the austenitic stainless steel cutter body 3 through a high power density laser pulse cladding process details as follows: As shown in FIGS. 2 to 4, preferably, it is considered that the plasma electrofusion mechanism 5 in the plasma electrofusion step will have a process of ignition at the beginning and a process of closing the fire at the end. The above two processes may cause unnecessary damage to the cutting edge of the austenitic stainless steel cutter body 3. Therefore, before performing the plasma electrofusion step, we adopt the existing mold stamping forming or laser cutting forming, and the austenitic stainless steel cutter body 3 is provided with a cutting edge extension area 35. It can avoid damage to the edge of the austenitic stainless steel cutter body 3 during the initial and final processing of plasma electrofusion; The cutting edge extension zone 35 extends along the direction of the cutting edge contour of the austenitic stainless steel cutter body 3 and protrudes from both sides of the austenitic stainless steel cutter body 3. The cutting edge extension area 35 includes an initial extension area 351 and an end extension area 352 respectively arranged at both ends of the austenitic stainless steel cutter body 3 in the direction of the edge contour line. The thicknesses of the initial extension zone 351 and the end extension zone 352 match the thickness of the austenitic stainless steel cutter body 3.

Regarding the low-carbon high-chromium martensitic alloy powder, it is a mixture of iron-based alloy powder and titanium carbide alloy powder, and its thickness is 150-180 mesh. Among them, the mass proportion of iron-based alloy powder is 50-80%, and the mass proportion of titanium carbide alloy powder is 20-50%; In terms of mass percentage, the iron-based alloy powder includes: 0.2-0.5% Mn, 0.6-0.9% Si, 0.55-0.75% Ni, 15-18% Cr, 0.05-0.09% P, 0.05-0.15% N, 0.2-0.3% % C, 0.005-0.016% S, 0.16-0.35% Mo, 0.15-0.2% Nb, 8-12% Ti, 1-2.5% V, and the balance is Fe.

Specifically, in this embodiment, the iron-based alloy powder and the titanium carbide alloy powder in the low-carbon high-chromium martensitic alloy powder each account for 50%. Among them, in terms of mass fraction, the iron-based alloy powder includes 0.2% Mn, 0.6% Si, 0.5% Ni, 15% Cr, 0.05% P, 0.05% N, 0.2% C, 0.005% S, 0.16% Mo, 0.15% Nb, 8% Ti, 1% V, the rest is Fe;

But not limited thereto, in this embodiment, the iron-based alloy powder in the low-carbon high-chromium martensitic alloy powder can also be the following ratio: by mass fraction, including 0.5% Mn, 0.9% Si, 0.75% Ni, 18% Cr, 0.09% P, 0.15% N, 0.3% C, 0.016% S, 0.35% Mo, 0.2% Nb, 12% Ti, 2.5% V, and the balance is Fe.

In the plasma electrofusion step, it includes: a plasma electrofusion mechanism 5 and an orbital working platform 4. The plasma electrofusion mechanism 5 performs a high frequency density laser pulse cladding process through the orbital working platform 4. Therefore, the track-type working platform 4 of this solution adopts a multi-axis linkage structure to realize accurate control of the position of the output end of the plasma electrofusion device, and it is driven by the movement of the linear module. It has the advantages of high precision, good stability and high process controllability. It can precisely and accurately perform plasma electrofusion on the cutting edge of the austenitic stainless steel cutting body 3, so as to greatly improve the qualification rate of the cutting edge cladding.

In the high power density laser pulsation cladding process in the plasma electrofusion step, the plasma electrofusion speed is 10-15 mm/s, the pulsation frequency is 3-5 kHz, the duty cycle is 75-95%, and the laser power The density is 250-350 W/mm2. The duty cycle refers to the ratio of the power-on time to the total time in a pulse cycle.

Therefore, this scheme provides the specific implementation parameters of the high-power-density laser pulsation cladding process. Using the high-frequency-density laser pulsation cladding process, the laser power density of 250-350 W/mm2 is 1% higher than the traditional plasma electrofusion power density times. It can fully melt two materials with different melting points to form a good metallurgical bond, and solves a series of problems derived from the large difference between the melting points of traditional austenitic stainless steel and martensitic alloy powder (refer to the background technology); Secondly, the cladding speed is increased to 10-15 mm/s, so that the plasma electrofusion has good processing efficiency; finally, we use the pulsating laser control process in the plasma electrofusion process. It controls the surface tension of the molten pool of plasma electrofusion by modulating the pulse frequency and duty cycle of the laser light to prevent the collapse of the molten pool.

In S3, on the premise that the material of the austenitic stainless steel cutter body 3 is austenitic stainless steel, this scheme adds materials by cladding a special ratio of alloy powder on the cutting edge of the austenitic stainless steel cutter body 3 layer to obtain a high-hardness and high-toughness edge layer with an HRC of 60-63 degrees; It can be seen that, in this embodiment, the austenitic stainless steel cutter body 3 made of austenitic stainless steel is cold-rolled and hardened, so that the processing cutter 3 can reach a preliminary hardness performance. Then we combine the alloy powder in the plasma electric melting step to further improve the hardness and toughness of the austenitic stainless steel cutter body 3, so that the austenitic stainless steel cutter body 3 can obtain excellent cutting ability. Moreover, in S3, the plasma electrofusion mechanism 5 of this solution is combined with the rail-type working platform 4, through the accurate grasp and control of the plasma electrofusion position of the austenitic stainless steel cutter body 3. It can effectively improve the alloy powder with special composition ratio on the austenitic stainless steel cutter body 3 that can be accurately plasma-fused, thereby effectively improving the hardness and toughness of the cutting edge of the austenitic stainless steel cutter body 3.

S4, tempering treatment steps:

We place the austenitic stainless steel cutter body 3 after the plasma melting step in S3 into a heat treatment furnace for low-temperature tempering treatment. The temperature is 160° C. and the time is 4 h (hours). Then we heat and keep the austenitic stainless steel cutter body 3 in the heat treatment furnace, and then cut off the energy source of the heat treatment furnace, so that the austenitic stainless steel cutter body 3 is cooled with the heat treatment furnace. But not limited thereto, the low-temperature tempering temperature can also be 200° C., and the time is 6 hours (hours). The tempering process carried out at this temperature can further improve the toughness and sharpness durability of the austenitic stainless steel cutter body 3 through repeated tests, and then obtain the excellent cutting performance of the cutter.

S5, sharpening processing step;

We sharpen the austenitic stainless steel cutter body 3, as follows;

Multi-stage sharpening steps:

In the first level of sharpening, the austenitic stainless steel cutter body 3 is roughly cut by using an angle fixer, and the edge inclination of one side of the fixed-angle austenitic stainless steel cutter body 3 is 12-13 degrees. It uses the angle between the two sides of the austenitic stainless steel cutter body 3 to form a preliminary angle of the cutting edge, that is, the sum of the inclinations of the two sides of the austenitic stainless steel cutter body 3, and determines the width of the cutting edge. Now the cutting edge of the austenitic stainless steel cutter body 3 is in a relatively rough state;

In the second stage of sharpening, we use a wet disc sharpening machine to re-sharpen the austenitic stainless steel body 3 so that the cutting edge of the austenitic stainless steel body 3 forms a finer tip edge. To reduce the cutting resistance of the austenitic stainless steel cutter body 3, thereby improving the cutting performance of the austenitic stainless steel cutter body 3; Too small means that the mesh number of the grinding wheel used by the sharpening machine in the current step is larger than the mesh number of the grinding wheel used by the sharpening machine in the previous step, that is, a coarser mesh number. For example, in the previous step, the sharpening machine used a 120-mesh grinding wheel for rough cutting at a fixed angle, and then replaced it with a 400-mesh grinding wheel in the current step to perform super-young re-cutting.

In the third level of cutting, we use a wet disc cutting machine to repair the cutting edge of the austenitic stainless steel body 3, so as to repair the edge angle left by the rough cutting edge and the too young double cutting edge, and then Improve the cutting smoothness of the final cutting edge of the austenitic stainless steel cutter body 3;

In the fourth stage of sharpening, we use a leather flap wheel to grind the edge of the austenitic stainless steel cutter body 3 to polish the remaining burrs on the surface of the austenitic stainless steel cutter body 3.

Then we check the edge angle of the austenitic stainless steel cutter body 3, and check the sharpness of the austenitic stainless steel cutter body 3 through processes such as cloth wheel scratching, hemp wheel pulling the mouth, and trial cutting newspapers.

After the austenitic stainless steel cutter body 3 undergoes the plasma electrofusion step of S3, it will form sintered protrusions caused by the plasma electrofusion alloy powder on its cutting edge. Therefore, before the step S5, this embodiment preferably needs to perform end face grinding on the entire blade surface of the cutting edge of the austenitic stainless steel cutter body 3 after the step S3 plasma electrofusion. We make the cutting edge thickness after plasma electrofusion treatment smaller than the thickness of the cutter body base material itself of the austenitic stainless steel cutter body 3. After completing this preferred step, perform the multi-stage sharpening treatment of S5.

S6. Steps of knife face grinding:

In the embodiment, we use the principle of vacuum adsorption and a special vacuum adsorption fixture to control the attachment of the austenitic stainless steel cutter body 3 to the fixture by vacuum suction to perform end face grinding.

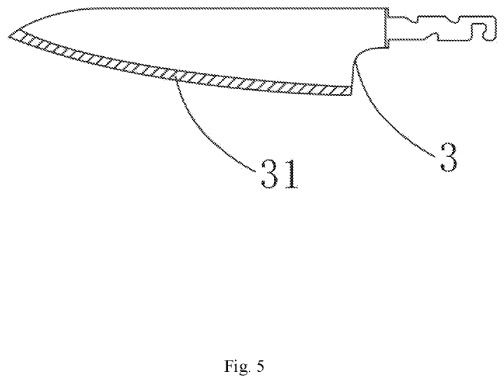

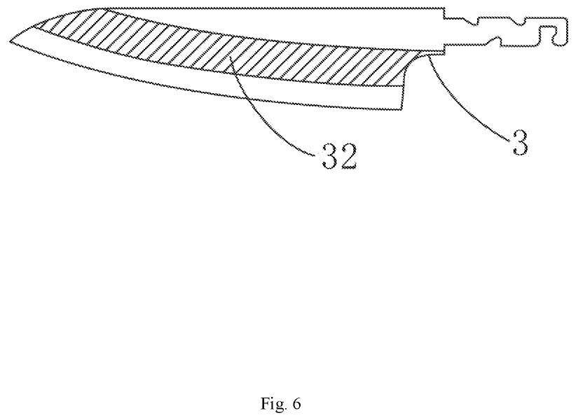

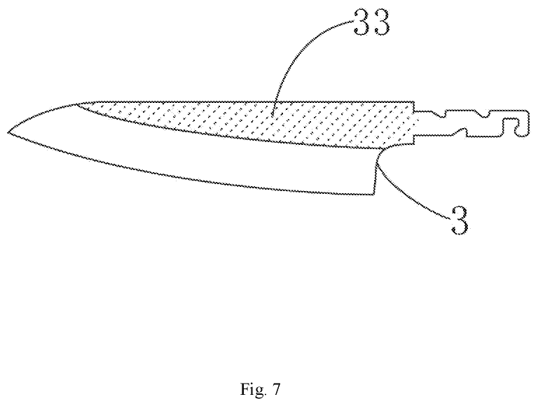

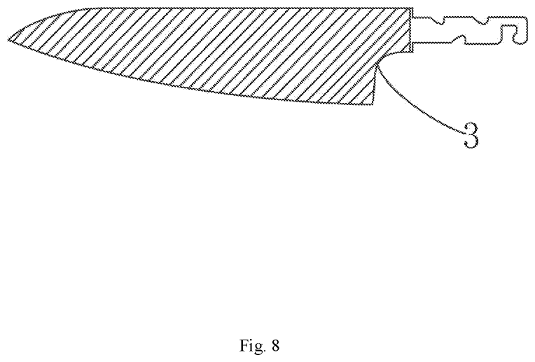

In the step S6, as shown in FIG. 5-FIG. 8, we divide the blade surface of the austenitic stainless steel cutter body 3 into an edge region 31, a transition region 32, and a blade back region 3;

S7. Face grinding steps:

Along the extension direction of the cutting edge contour line of the austenitic stainless steel cutter body 3, the cutting edge region 31, the transition region 32, and the blade back region 3 are sequentially ground. Wherein, the machining paths of the cutting edge area 31 and the transition area 32 are parallel to the cutting edge outline of the austenitic stainless steel cutter body 3. We perform integral face grinding on the face of the austenitic stainless steel body 3.

S8, cleaning steps:

We soak in warm water with a temperature of 80° C., containing 2‰ brightener and 3‰ dewaxing water by mass percentage for about 30 minutes. We then clean the wax stains left by the cortical flap wheels in steps S6 and S7 to restore the surface brightness and cleanliness of the austenitic stainless steel cutter body 3; finally, we place the cutter in an automatic cleaning machine for cleaning and drying.

In this scheme, the knife face of the austenitic stainless steel cutter body 3 is divided reasonably, so as to plan the processing path of the knife face grinding; Arranging, the first step of knife face grinding is performed from the cutting edge area 31, so the position of the first step of knife face grinding is the cutting edge area 31 where the cutting performance of the austenitic stainless steel cutter body 3 is reflected. Then we carry out a second step of face grinding on the transition zone 32, followed by a third step of grinding on the back zone 3. Finally, we carry out overall grinding to the whole blade surface of the austenitic stainless steel cutter body 3;

It can be seen that the grinding sequence of the knife face of this scheme is sequentially processed in a coherent manner, so it can maximize the reasonable smooth plane between the cutting edge area 31 and the transition area 32, compared with the traditional knife face grinding process. In this solution, no uneven ridge-shaped protrusions can be formed between the cutting edge area 31 and the transition area 32, so as to promote the cutting edge of the austenitic stainless steel cutter body 3 to form a clam edge angle. It is not easy to cause the knife pushing action caused by the knife pushing the object to be cut, thereby improving the user experience.

TABLE 1
Cutting performance experiment data table

| | Edge Hardness (HRC) | | | | Initial | Cut |
|---|---|---|---|---|---|---|
| | First | Second | Third | Edge | Sharpness | Value |
| Item | Time | Time | Time | Angle | ICP | TCC |
| 1 | 62 | 61.5 | 62.5 | 23 | 177.1 | 867.4 |
| 2 | 61.5 | 62.3 | 62.7 | 25 | 173.9 | 615.6 |
| 3 | 61.3 | 62.8 | 61.5 | 26 | 162 | 546.2 |
| 4 | 1.5 | 60.6 | 60.8 | 25 | 149.6 | 593 |
| 5 | 62.5 | 61.5 | 62.6 | 24 | 187.3 | 770 |
| 6 | 60.5 | 61.5 | 61 | 25 | 142.5 | 589 |

Table 1 is the cutting performance experiment data table after using the same batch of raw materials according to the processing method of the above embodiment. The first, second, and third times refer to the number of detection times of cutting edge hardness, the purpose is to reduce the number of measuring equipment Or the experimental data error caused by external factors. We guarantee the objective authenticity of the experimental data; The cutting edge angle is the sum of the inclinations of the two sides of the austenitic stainless steel cutter body 3; it can be seen that the cutting edge hardness of the novel austenitic stainless steel kitchen knives produced by the production method of this program is HRC60-63. Its sharpness and durability are subject to the European Union IS0842-5 standard test, which is at an excellent level. Specifically: the initial sharpness ICP>110, specifically based on cutting 3 knives. Sharpness and durability TCC>500, specifically based on cutting 60 knives. The HRC of traditional martensitic stainless steel is 53-56, and the sharpness and durability are at the general level. Specifically: ICP50-80, TCC100-280. In comparison, the cutting tool of the present invention has better cutting performance.

In knife face grinding, since the machining paths of the cutting edge region 31 and the transition region 32 are parallel to the cutting edge contour line of the austenitic stainless steel cutter body 3, the gap between the cutting edge region 31 and the transition region 32 can be effectively improved. The smoothness of the joint. It can make the knife surface of the austenitic stainless steel knife body 3 smoother, thereby improving the user experience. In this embodiment, the cutting edge region 31 accounts for 10% of the cutting surface area of the austenitic stainless steel cutting body 3. The transition zone 32 accounts for 35% of the surface area of the austenitic stainless steel cutter body 3 In this solution, the processing areas of the cutting edge area 31 and the transition area 32 are designed and controlled. It can effectively improve the smoothness of the connection between the cutting edge area 31 and the transition area 32, so as to make the knife surface of the austenitic stainless steel knife body 3 smoother, thereby improving the user experience.

In this embodiment, the rail-type working platform 4 includes an X-axis linear movement mechanism 41, a Y-axis linear movement mechanism 42, and a Z-axis linear movement mechanism 43. The X-axis linear movement mechanism 41 is movably disposed on the movable end of the Y-axis linear movement mechanism 42. The Z-axis linear movement mechanism 43 is movably disposed on the movable end of the X-axis linear movement mechanism 41. The plasma electrofusion mechanism 5 is arranged on the movable end of the Z-axis linear movement mechanism 43; Specifically, the X-axis linear movement mechanism 41, the Y-axis linear movement mechanism 42, and the Z-axis linear movement mechanism 43 are the movement mechanisms of the guide rail slider. The multi-axis customized machine of this scheme can increase the grinding force of the grinding process of the 3 cutter faces of the austenitic stainless steel cutter body. It can more precisely control the flatness of the blade after grinding. But not limited thereto, the orbital working platform 4 can also be a six-axis motion mechanism using the XYZ axis coordinate system.

In this solution, the orbital working platform 4 adopts a multi-axis linkage structure through the three-axis linkage of X, Y, and Z axes. It can accurately control the position of the output end of the plasma electrofusion mechanism 5, and it is driven by the movement of the linear module. It has the advantages of high precision, good stability and high process controllability. It can precisely and accurately perform plasma electrofusion on the cutting edge of the austenitic stainless steel cutting body 3, so as to greatly improve the qualification rate of the cutting edge cladding.

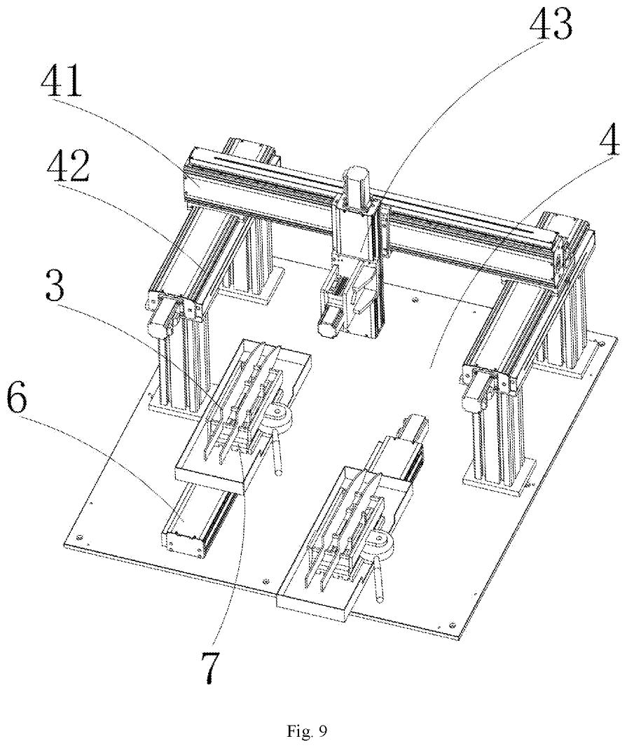

In this embodiment, as shown in FIG. 9, the rail-type working platform 4 is provided with a fourth-axis linear movement mechanism 6. The movable end of the fourth-axis linear moving mechanism 6 is provided with a fixing fixture 7. The austenitic stainless steel cutter body 3 is installed in the fixing fixture 7; In this solution, the orbital working platform 4 is combined with the fourth axis linear moving mechanism 6. It adopts a simple structure to form a four-axis motion mechanism, coupled with the characteristics of fast response and high precision of the upper linear module. This scheme has higher precision of plasma electrofusion processing.

In the step of grinding the knife face of S5, we use the first grinding wheel to roughly grind the end face of the knife face of the austenitic stainless steel cutter body 3. The first sharpening wheel adopts a resin emery wheel, which is added with a material containing 25% white corundum in terms of mass percentage;

We carry out the end face superfine grinding to the knife face of austenitic stainless steel cutter body 3 by the second sharpening wheel. The second sharpening wheel adopts a synthetic rubber grinding wheel, which is added with 10% black corundum material and 20% ceramic alumina material in terms of mass percentage.

Compared with the traditional brown corundum material grinding wheel used for the first grinding wheel for rough grinding of the end face. The rubber grinding wheel used for the second grinding wheel for superfine grinding. The present invention changes the grinding wheel material. This is conducive to improving production efficiency, improving the flatness of the tool surface, improving the user's smoothness in the cutting process, and improving the experience.

The traditional sharpening method is one-time sharpening with a dry or wet disc sharpening machine. In this plan, the austenitic stainless steel cutter body 3 is sharpened in multiple stages, and the characteristics and functions of each stage are reasonably arranged to ensure the sharpness and durability of the cutting edge of the austenitic stainless steel cutter body 3 to the greatest extent. Spend. This reduces the number of times the user will repeatedly sharpen the blade in the future, thereby facilitating the improvement of user experience.

The angle fixer can make the edge inclination of one side of the austenitic stainless steel cutter body 3 reach 12-13 degrees, so as to ensure the sharpness and durability of the edge of the austenitic stainless steel cutter body 3 to the greatest extent. This reduces the number of times the user will repeatedly sharpen the blade in the future, thereby facilitating the improvement of user experience.

### Beneficial Effect

This solution adopts austenitic stainless steel cutter body 3, which can effectively solve the problems of traditional martensitic stainless steel cutters, such as low anti-corrosion and anti-rust performance, high hazard of heavy metal precipitation, and poor food-grade contact safety; Secondly, in this solution, a layer of low-carbon high-chromium martensitic alloy powder is plasma-fused on the surface of the austenitic stainless steel cutter body 3, so as to greatly improve the corrosion resistance and toughness of the cutting edge, so that its hardness can reach HRC60-HRC63, which solves the problems of insufficient corrosion resistance and insufficient durability of good sharpness of traditional martensitic stainless steel knives. Secondly, this scheme is based on the combination of the austenitic stainless steel cutter body 3 and the low-carbon high-chromium martensitic alloy powder. We use high-frequency density laser pulsation cladding process for plasma electrofusion step, which solves the problems of welding deformation and welding cracks in traditional two-metal welding, as well as cladding layer collapse and appearance in traditional plasma electrofusion process. Pore problem. In this way, the flattening rate of the tool is further improved and the process cost of plasma electrofusion is reduced, so that this tool processing method can be better promoted.

Finally, the present invention rationally divides the knife face of the austenitic stainless steel cutter body 3 so as to plan the processing path of the knife face grinding; On the basis of obtaining the austenitic stainless steel cutter with good cutter performance through plasma electrofusion, we divide the cutter face of the austenitic stainless steel cutter body 3 reasonably. It makes the final new austenitic stainless steel kitchen knives have good anti-corrosion and anti-rust properties, good hardness, good cutting sharpness, and good sharpness and durability.

### Embodiment Two

A low-carbon high-chromium martensitic alloy powder can be applied to the production method of the novel austenitic stainless steel kitchen knives in the first embodiment. It is a mixture of iron-based alloy powder and titanium carbide alloy powder. Its thickness is 150-180 mesh. Among them, the mass proportion of iron-based alloy powder is 50-80%, and the mass proportion of titanium carbide alloy powder is 20-50%; In terms of mass percentage, the iron-based alloy powder includes 0.2-0.5% Mn, 0.6-0.9% Si, 0.55-0.75% Ni, 15-18% Cr, 0.05-0.09% P, 0.05-0.15% N, 0.2-0.3% C, 0.005-0.016% S, 0.16-0.35% Mo, 0.15-0.2% Nb, 8-12% Ti, 1-2.5% V and the rest is Fe. Therefore, we clad the alloy powder additive layer on the cutting edge of the knife body to obtain a high-hardness and high-toughness cutting edge layer with an HRC of 60-63 degrees to achieve excellent cutting ability.

Specifically, in this embodiment, the iron-based alloy powder and the titanium carbide alloy powder in the low-carbon high-chromium martensitic alloy powder each account for 50%. Among them, in terms of mass fraction, the iron-based alloy powder includes 0.2% Mn, 0.6% Si, 0.5% Ni, 15% Cr, 0.05% P, 0.05% N, 0.2% C, 0.005% S, 0.16% Mo, 0.15% Nb, 8% Ti, 1% V. The balance is Fe;

But not limited thereto, in this embodiment, the iron-based alloy powder in the low-carbon high-chromium martensitic alloy powder can also be the following ratio: by mass fraction, including 0.5% Mn, 0.9% Si, 0.75% Ni, 18% Cr, 0.09% P, 0.15% N, 0.3% C, 0.016% S, 0.35% Mo, 0.2% Nb, 12% Ti, 2.5% V The balance is Fe.

This specific embodiment is only an explanation of the present invention, and it is not a limitation of the present invention. Those skilled in the art may make modifications to this embodiment without creative contribution after reading this specification. But as long as it is within the scope of the claims of the present invention, it is protected by the patent law.

What is claimed is:

1. The production method of novel austenitic stainless steel kitchen cutter is characterized in that, comprises the following steps:
Knife body forming: provide austenitic stainless steel knife body; Plasma electrofusion: cladding low-carbon high-chromium martensitic alloy powder onto the austenitic stainless steel cutter body through a high-power-density laser pulse cladding process; Tempering treatment: tempering the austenitic stainless steel cutter body;
Grinding the knife surface: dividing the knife surface of the austenitic stainless steel cutter body into a cutting edge area, a transition area, and a knife back area;
End face grinding: along the extension direction of the cutting edge contour line of the austenitic stainless steel cutter body, carry out regional end face grinding on the cutting edge area, the transition area, and the knife back area one by one;
Carrying out integral end face grinding to the cutter face of described austenitic stainless steel cutter body;
Sharpening treatment: performing sharpening treatment on the austenitic stainless steel cutter body.

2. The production method of novel austenitic stainless steel kitchen knife according to claim 1, is characterized in that, before described plasma electrofusion step, described austenitic stainless steel cutter body is provided with cutting edge extension zone. It can avoid damage to the cutting edge of the austenitic stainless steel cutter body caused by the initial and final processing of plasma electrofusion.

3. The production method of novel austenitic stainless steel kitchen cutter according to claim 1, is characterized in that, by mass percentage, before described cutter body shaping step, it also comprises raw material cold rolling hardening step. That is, the soft raw material austenitic stainless steel is selected as the raw material for cold rolling and hardening.

4. The production method of austenitic stainless steel kitchen cutting tools according to claim 1, characterized in that in the laser pulse cladding process in the laser cladding step, the laser cladding speed is 10-15 mm/s, and the duty cycle is 75-95%.

5. The production method of novel austenitic stainless steel kitchen knives according to claim 1, characterized in that, in the step of tempering. Its tempering temperature is 160-200° C. Its time is 4-6 h.

6. The production method of novel austenitic stainless steel kitchen knives according to claim 1, characterized in that, in the high power density laser pulse cladding process in the plasma electrofusion step. Its plasma melting speed is 10-15 mm/s. Its pulse frequency is 3-5 kHz. Its duty cycle is 75-95%. Its laser power density is 250-350 W/mm².

7. The production method of novel austenitic stainless steel kitchen knives according to claim 6, wherein the orbital work platform includes an X-axis linear movement mechanism, a Y-axis linear movement mechanism, and a Z-axis linear movement mechanism; The X-axis linear movement mechanism is movably arranged on the movable end of the Y-axis linear movement mechanism. The Z-axis linear movement mechanism is movably arranged on the movable end of the X-axis linear movement mechanism. The plasma electrofusion mechanism is arranged on the movable end of the Z-axis linear movement mechanism.

8. The production method of novel austenitic stainless steel kitchen knives according to claim 1, characterized in that, in the step of grinding the knife face, it passes through the first grinding wheel to the austenitic stainless steel knife The knife face of the body is rough ground. The first grinding wheel is a resin grinding wheel, which is added with 25-35% white corundum in mass percentage; It uses the second grinding wheel to grind the end face of the austenitic stainless steel cutter body for over-fine grinding. The second grinding wheel is a synthetic rubber grinding wheel, which is added with 10-15% black corundum and 15%-20% ceramic alumina in mass percentage.

9. The production method of novel austenitic stainless steel kitchen knife according to claim 1. It is characterized in that the sharpening step includes:
Multi-stage sharpening:
The first level of sharpening is to roughly cut the edge of the austenitic stainless steel cutter body to form a cutting edge angle;
The second stage of sharpening, the austenitic stainless steel cutter body is thinned and re-sharpened to reduce cutting resistance;
The third level of cutting is to repair the cutting edge of the austenitic stainless steel cutter body to repair the cutting edge angle left by the rough cutting edge and the too young double cutting edge, so as to improve the cutting smoothness of the cutting edge; The fourth stage of sharpening is to grind the edge of the austenitic stainless steel cutter body to grind the remaining burrs on the surface of the austenitic stainless steel cutter body.

10. A low-carbon high-chromium martensitic alloy powder, characterized in that it can be applied to the production method of the novel austenitic stainless steel kitchen knives as claimed in any one of claims 1 to 8. It is a mixture of iron-based alloy powder and titanium carbide alloy powder. Among them, the mass proportion of iron-based alloy powder is 50-80%, and the mass proportion of titanium carbide alloy powder is 20-50%; In terms of mass percentage, the iron-based alloy powder includes 0.2-0.5% Mn, 0.6-0.9% Si, 0.55-0.75% Ni, 15-18% Cr, 0.05-0.09% P, 0.05-0.15% N, 0.2 -0.3% C, 0.005-0.016% S, 0.16-0.35% Mo, 0.15-0.2% Nb, 8-12% Ti, 1-2.5% V, and the rest is Fe.
